(19) United States
(12) Patent Application Publication
(10) Pub. No.: US 2025/0095169 A1
(43) Pub. Date: Mar. 20, 2025

(54) CAMERA POSE REFINEMENT WITH GROUND-TO-SATELLITE IMAGE REGISTRATION

(71) Applicants: Ford Global Technologies, LLC, Dearborn, MI (US); Australian National University, Canberra (AU)

(72) Inventors: Yujiao Shi, Canberra/ACT (AU); Hongdong Li, Lyneham/ACT (AU); Akhil Perincherry, Dearborn, MI (US); Ankit Girish Vora, Northville, MI (US)

(73) Assignees: Ford Global Technologies, LLC, Dearborn, MI (US); Australian National University, Canberra (AU)

(21) Appl. No.: 18/468,981

(22) Filed: Sep. 18, 2023

(51) Int. Cl. G06T 7/33; G06T 7/73; G06V 10/44; G06V 10/77; G06V 10/82; G06V 20/13

(52) U.S. Cl. CPC G06T 7/33; G06T 7/73; G06V 10/44; G06V 10/7715; G06V 10/82; G06V 20/13; G06T 2207/10032; G06T 2207/20081; G06T 2207/20084; G06T 2207/30252

(57) ABSTRACT

A computer that includes a processor and a memory, the memory includes instructions executable by the processor to estimate a relative rotation between a ground view image and an aerial view image with a rotation estimator. A ground feature map and a confidence map corresponding to the ground view image are projected to an aerial feature map corresponding to the aerial view image according to the relative rotation to create a projected overhead-view feature map. A translation difference is determined between the projected overhead-view feature map and the aerial feature map using spatial correlation. A high-definition estimated three degree-of-freedom pose of a ground view camera is determined based on the relative rotation and the translation difference.

### BACKGROUND

Computers can be used to operate systems including vehicles, robots, drones, and/or object tracking systems. Data including images can be acquired by sensors and processed using a computer to determine a location of a system with respect to objects in an environment around the system. The computer may use the location to determine trajectories for moving a system in the environment. The computer may then determine control data to transmit to system components to control the system components to move the components according to the determined trajectories.

### BRIEF DESCRIPTION OF THE DRAWINGS

FIG. 1 is a block diagram of an example vehicle sensing system.

FIG. 2 is a diagram of an example satellite image including a vehicle.

FIG. 3 is a diagram of another example satellite image including a vehicle.

FIG. 4A is a diagram of an example system for training a rotation estimator system as shown in FIG. 4B.

FIG. 4B is a diagram of an example rotation estimator to determine an estimated relative rotation between ground and aerial images.

FIG. 5 is a diagram of an example pose refinement system to determine a high-resolution three degree-of-freedom vehicle location in global coordinates.

FIG. 6 is a flowchart diagram of an example process to determine a high-resolution three degree of freedom vehicle location in global coordinates.

FIG. 7 is a flowchart diagram of an example process to determine an estimated relative rotation between ground and aerial images.

FIG. 8 is a flowchart diagram of an example process to operate a vehicle based on a high-resolution vehicle location in global coordinates.

### DETAILED DESCRIPTION

Systems including vehicles, robots, drones, etc., can be operated by acquiring sensor data regarding an environment around the system and processing the sensor data to determine a path upon which to operate the system or portions of the system. The sensor data can be processed to determine locations of objects in an environment. The objects can include roadways, buildings, conveyors, vehicles, pedestrians, manufactured parts, etc. Sensor data can be processed to determine a pose for the system, where a “pose” specifies a location and an orientation of an object such as a system and/or components thereof. A system pose can be determined based on a full six degree-of-freedom (DoF) pose which includes x, y, and z location coordinates, and roll, pitch, and yaw rotational coordinates with respect to the x, y, and z axes, respectively. The six DoF pose can be determined with respect to a global coordinate system such as a Cartesian coordinate system in which points can be specified according to latitude, longitude, and altitude or some other x, y, and z axes.

A vehicle is used herein as a non-limiting example of a system. Vehicles can be located with respect to an environment around the vehicle using a simpler three DoF pose that assumes that the vehicle is supported on a planar surface such as a roadway which fixes the z, pitch, and roll coordinates of the vehicle to match the roadway. The vehicle pose can be described by x and y position coordinates and a yaw rotational coordinate to provide a three DoF pose that defines the vehicle location and orientation with respect to a supporting surface.

Vehicle sensors can provide data that can be used to determine a vehicle pose and that in turn can be used to locate a vehicle with respect to an aerial image that includes location data in global coordinates. For example, vehicle sensors may provide data for determining location and/or pose based on a satellite-based global positioning system (GPS) and/or an accelerometer-based inertial measurement unit (IMU). The location data included in the aerial image can be used to determine a location in global coordinates of any pixel address location in the aerial image, for example. An aerial image can be obtained by satellites, airplanes, drones, or other aerial platforms. Satellite data will be used herein as a non-limiting example of aerial image data. For example, satellite images can be obtained by downloading GOOGLE™ maps or the like from the Internet.

Determining a pose of an object such as a vehicle with respect to satellite image data using global coordinate data included in or with the satellite images can typically provide pose data within +/−3 meters location and +/−3 degrees of orientation resolution. Operating a vehicle may rely on pose data that includes one meter or less resolution in location and one degree or less resolution in orientation. For example, +/−3 meter location data may not be sufficient to determine the location of a vehicle with respect to a traffic lane on a roadway. Techniques for satellite image guided geo-localization as discussed herein can determine vehicle pose within a specified resolution, typically within one meter or less resolution in location and one degree or less resolution in orientation, e.g., a resolution sufficient to operate a vehicle on a roadway. Vehicle pose data determined within a specified resolution, i.e., that exceeds one or more specified resolution thresholds, e.g., one meter or less resolution in location and one degree or less resolution in orientation in an exemplary implementation, is referred to herein as high-definition pose data.

Techniques described herein employ satellite image guided geo-localization to enhance determination of a high-definition pose for a vehicle. Satellite image guided geo-localization uses images acquired by sensors included in a vehicle to determine a high-definition pose with respect to satellite images without requiring predetermined high-definition (HD) maps. The vehicle sensor images, and the satellite images are input to a rotation estimator and two separate neural networks which extract features from the images along with confidence maps. In some examples the two separate neural networks can be the same neural network. 3D feature points from the vehicle images are matched to 3D feature points from the satellite images to determine a high-definition pose for the vehicle with respect to the satellite image. The high-definition pose for the vehicle can be used to operate the vehicle by determining a vehicle path based on the high-definition path.

Disclosed herein is a system including a computer that includes a processor and a memory. The memory includes instructions executable by the processor to estimate a relative rotation between a ground view image and an aerial view image with a rotation estimator. A ground feature map and a confidence map corresponding to the ground view image are projected to an aerial feature map corresponding to the aerial view image according to the relative rotation to create a projected overhead-view feature map. A translation difference is determined between the projected overhead-view feature map and the aerial feature map using spatial correlation. A high-definition estimated three degree-of-freedom pose of a ground view camera is determined based on the relative rotation and the translation difference.

The system can include further instructions to determine the ground feature map and the confidence map from the ground view image with a first neural network and instructions to determine the aerial feature map from the aerial view image with a second neural network. The system can be supervised using a combination of self-supervised learning and weak supervision.

The rotation estimator can include instructions to extract ground features from the ground view image with a third neural network and extract aerial features from the aerial view image with a fourth neural network. The rotation estimator can include instructions to project the ground features to the aerial features to create an overhead view projection. The rotation estimator can include instructions to estimate the relative rotation between the ground features and the overhead view projection with a neural pose optimizer.

The estimated three degree-of-freedom pose of the ground view camera can be determined based on an initial estimate of the three degree-of-freedom pose of the ground view camera. The first and second neural networks can have a U-net architecture. The aerial view image can be a satellite image.

The high-definition estimated three degree-of-freedom pose of the ground view camera is output and used to operate a vehicle. The high-definition estimated three degree-of-freedom pose of the ground view camera and the aerial view image are used to determine a vehicle path upon which to operate the vehicle.

Disclosed herein is a method including estimating a relative rotation between a ground view image and an aerial view image with a rotation estimator. The method can include projecting a ground feature map and a confidence map corresponding to the ground view image to an aerial feature map corresponding to the aerial view image according to the relative rotation to create a projected overhead-view feature map. A translation difference between the projected overhead-view feature map and the aerial feature map is determined using spatial correlation. The method can also include determining a high-definition estimated three degree-of-freedom pose of a ground view camera based on the relative rotation and the translation difference.

The method can further comprise determining the ground feature map and the confidence map from the ground view image with a first neural network and determining the aerial feature map from the aerial view image with a second neural network. The first and second neural networks can be supervised using a combination of self-supervised learning and weak supervision.

The method can further comprise randomly rotating and translating aerial training images and training the rotation estimator based on the aerial training images and the randomly rotated and translated aerial training images. The method can further comprise extracting a triangle region of the randomly rotated and translated aerial training images. Estimating the relative rotation can include extracting ground features from the ground view image with a third neural network and extracting aerial features from the aerial view image with a fourth neural network.

Estimating the relative rotation can include projecting the ground features to the aerial features to create an overhead view projection. Estimating the relative rotation can include estimating the relative rotation between the ground features and the overhead view projection with a neural pose optimizer. The estimated three degree-of-freedom pose of the ground view camera can be determined based on an initial estimate of the three degree-of-freedom pose of the ground view camera.

The method can further comprise outputting the high-definition estimated three degree-of-freedom pose of the ground view camera to operate a vehicle. The method can further comprise determining a vehicle path upon which to operate the vehicle based on the high-definition estimated three degree-of-freedom pose of the ground view camera and the aerial view image.

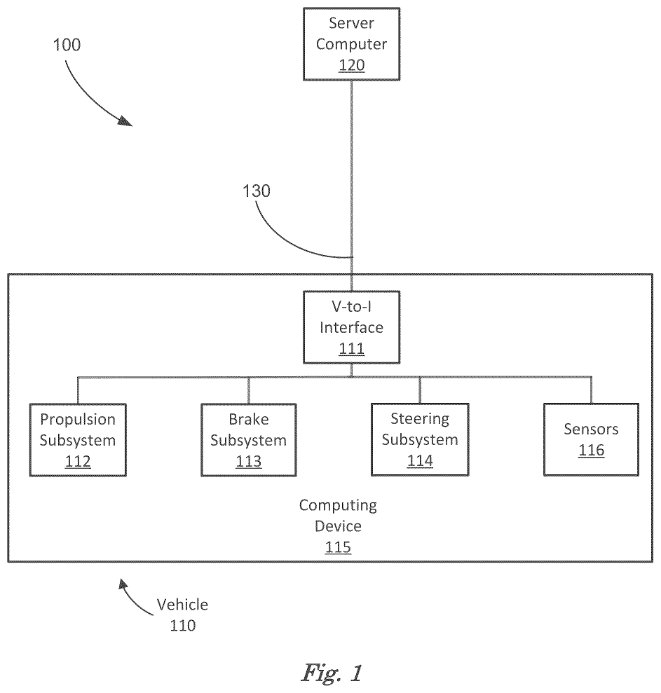

FIG. 1 is a diagram of a sensing system 100. Sensing system 100 includes a vehicle 110, operable by a user and/or according to control by a computing device 115 which can include one or more vehicle electronic control units (ECUs) or computers, such as are known, possibly including additional hardware, software, and/or programming as described herein. The computing device 115 can receive data regarding the operation of the vehicle 110 from sensors 116. The computing device 115 may operate the vehicle 110 or components thereof instead of or in conjunction with control by a human user. The system 100 can further include a server computer 120 that can communicate with the vehicle 110 via a network 130.

The computing device 115 includes a processor and a memory such as are known. Further, the memory includes one or more forms of computer-readable media, and stores instructions executable by the processor for performing various operations, including as disclosed herein. For example, the computing device 115 may include programming to operate one or more of vehicle brakes, propulsion (e.g., control of acceleration in the vehicle 110 by controlling one or more of an internal combustion engine, electric motor, hybrid engine, etc.), steering, climate control, interior and/or exterior lights, etc., as well as to determine whether and when the computing device 115, as opposed to a human operator, is to control such operations.

The computing device 115 may include or be communicatively coupled to, e.g., via a vehicle communications bus as described further below, more than one computing devices, e.g., controllers, ECUs, or the like included in the vehicle 110 for monitoring and/or controlling various vehicle subsystems, e.g., a propulsion subsystem 112, a brake subsystem 113, a steering subsystem 114, etc. The computing device 115 is generally arranged for communications on a vehicle communication network, e.g., including a bus in the vehicle 110 such as a controller area network (CAN) or the like; the vehicle network can additionally or alternatively include wired or wireless communication mechanisms such as are known, e.g., Ethernet or other communication protocols.

Via the vehicle network, the computing device 115 may transmit messages to various devices in the vehicle and/or receive messages from the various devices, e.g., controllers, actuators, sensors, etc., including sensors 116. Alternatively, or additionally, in cases where the computing device 115 actually comprises multiple devices, the vehicle communication network may be used for communications between devices represented as the computing device 115 in this disclosure. Further, as mentioned below, various controllers or sensing elements such as sensors 116 may provide data to the computing device 115 via the vehicle communication network.

In addition, the computing device 115 may be configured for communicating through a vehicle-to-infrastructure (V2X) interface 111 with a remote server computer 120, e.g., a cloud server, via a network 130, which, as described below, includes hardware, firmware, and software that permits computing device 115 to communicate with a remote server computer 120 via a network 130 such as wireless Internet (WI-FI®) or cellular networks. V2X interface 111 may accordingly include processors, memory, transceivers, etc., configured to utilize various wired and/or wireless networking technologies, e.g., cellular, BLUETOOTH®, Bluetooth Low Energy (BLE), Ultra-Wideband (UWB), Peer-to-Peer communication, UWB based Radar, IEEE 802.11, and/or other wired and/or wireless packet networks or technologies. Computing device 115 may be configured for communicating with other vehicles 110 through V2X (vehicle-to-everything) interface 111 using vehicle-to-vehicle (V-to-V) networks, e.g., according to including cellular communications (C-V2X) wireless communications cellular, Dedicated Short Range Communications (DSRC) and/or the like, e.g., formed on an ad hoc basis among nearby vehicles 110 or formed through infrastructure-based networks. The computing device 115 also includes nonvolatile memory such as is known. Computing device 115 can log data by storing the data in nonvolatile memory for later retrieval and transmittal via the vehicle communication network and a vehicle to infrastructure (V2X) interface 111 to a server computer 120 or user mobile device 160.

As already mentioned, generally included in instructions stored in the memory and executable by the processor of the computing device 115 is programming for operating one or more vehicle 110 components, e.g., braking, steering, propulsion, etc. Using data received in the computing device 115, e.g., the sensor data from the sensors 116, the server computer 120, etc., the computing device 115 may make various determinations and/or control various vehicle 110 components and/or operations. For example, the computing device 115 may include programming to regulate or control vehicle 110 operational behaviors (e.g., physical manifestations of vehicle 110 operation) such as speed, acceleration, deceleration, steering, etc., as well as tactical behaviors (e.g., control of operational behaviors typically in a manner intended to achieve efficient traversal of a route) such as a distance between vehicles and/or amount of time between vehicles, lane-change, minimum gap between vehicles, left-turn-across-path minimum, time-to-arrival at a particular location and intersection (without signal) minimum time-to-arrival to cross the intersection.

Each of the subsystems 112, 113, 114 may include respective processors and memories and one or more actuators. The subsystems 112, 113, 114 may be programmed and connected to a vehicle 110 communications bus, such as a controller area network (CAN) bus or local interconnect network (LIN) bus, to receive instructions from the computing device 115 and control actuators based on the instructions.

Sensors 116 may include a variety of devices such as are known to provide data via the vehicle communications bus. For example, a radar fixed to a front bumper (not shown) of the vehicle 110 may provide a distance from the vehicle 110 to a next vehicle in front of the vehicle 110, or a global positioning system (GPS) sensor disposed in the vehicle 110 may provide geographical coordinates of the vehicle 110. The distance(s) provided by the radar and/or other sensors 116 and/or the geographical coordinates provided by the GPS sensor may be used by the computing device 115 to operate the vehicle 110.

The vehicle 110 is generally a land-based vehicle 110 having three or more wheels, e.g., a passenger car, light truck, etc. The vehicle 110 includes one or more sensors 116, the V2X interface 111, the computing device 115 and one or more subsystems 112, 113, 114. The sensors 116 may collect data related to the vehicle 110 and the environment in which the vehicle 110 is operating. By way of example, and not limitation, sensors 116 may include, e.g., altimeters, cameras, LIDAR, radar, ultrasonic sensors, infrared sensors, pressure sensors, accelerometers, gyroscopes, temperature sensors, pressure sensors, hall sensors, optical sensors, voltage sensors, current sensors, mechanical sensors such as switches, etc. The sensors 116 may be used to sense the environment in which the vehicle 110 is operating, e.g., sensors 116 can detect phenomena such as weather conditions (precipitation, external ambient temperature, etc.), the grade of a road, the location of a road (e.g., using road edges, lane markings, etc.), or locations of target objects such as neighboring vehicles 110. The sensors 116 may further be used to collect data including dynamic vehicle 110 data related to operations of the vehicle 110 such as velocity, yaw rate, steering angle, engine speed, brake pressure, oil pressure, the power level applied to subsystems 112, 113, 114 in the vehicle 110, connectivity between components, and accurate and timely performance of components of the vehicle 110.

Server computer 120 typically has features in common, e.g., a computer processor and memory and configuration for communication via a network 130, with the vehicle 110 V2X interface 111 and computing device 115, and therefore these features will not be described further. A server computer 120 can be used to develop and train software that can be downloaded or otherwise installed to the computing device 115 in the vehicle 110.

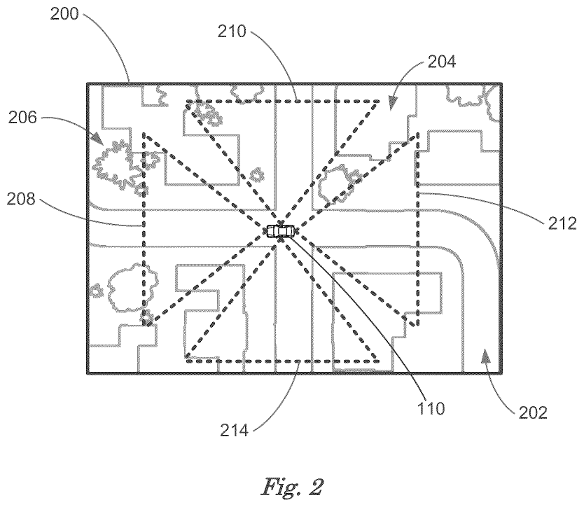

FIG. 2 is a diagram of a satellite image 200. Satellite image 200 can be a map downloaded to the computing device 115 in the vehicle 110 via the network 130, e.g., from a source such as GOOGLE maps. Satellite image 200 includes roadways 202, buildings 204, indicated by rectilinear shapes, and foliage 206, indicated by irregular shapes. The version of satellite images 200 used herein is the version that includes photographic likenesses of objects such as roadways 202, buildings 204 and foliage 206. Included in satellite image 200 is a vehicle, such as the vehicle 110. Vehicle 110 includes sensors 116, including video cameras. Included in satellite image 200 are four fields of view 208, 210, 212, 214 (e.g., spatial regions within which respective cameras can capture images) for four video cameras included at the front, right side, back, and left side of the vehicle 110, respectively.

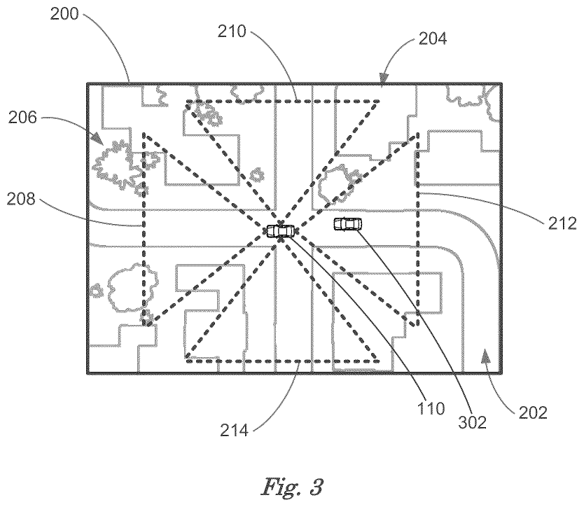

FIG. 3 is a diagram of the satellite image 200 that includes an estimated three DoF pose 302 of vehicle 110. For example, an initial estimated three DoF pose 302 of vehicle 110 with respect to the satellite image 200 can be based on vehicle sensor data including a GPS sensor included in vehicle 110. Because of the limited resolution of GPS sensors and limited resolution of satellite images 200, the estimated three DoF pose 302 of vehicle 110 typically does not represent a sufficiently accurate pose of vehicle 110. Because of limited resolutions of GPS sensors and satellite images 200, an estimated three DoF pose 302 typically is not be used to operate a vehicle 110.

One way to obtain high-definition data for operating vehicles 110 could be to produce HD maps for all areas upon which the vehicle 110 operates. High-definition maps typically require extensive mapping efforts and large amounts of computer resources to produce and store the HD maps, along with large amounts of network bandwidth typically consumed to download the HD maps to vehicles 110, not to mention the large amount of computer memory typically required to store the maps in computing devices 115 included in vehicles. Satellite image guided pose refinement techniques described herein use 3D feature points determined based on video images acquired by video cameras included in a vehicle 110 to determine a high-definition three DoF pose for a vehicle 110 based on satellite images without requiring large amounts of computer processing, networking, and/or memory resources typically required to produce, transmit, and store HD maps.

Images corresponding to fields of view 208, 210, 212, 214 can be acquired by video cameras included in vehicle 110. These images can be red, green, and blue (RGB) color images acquired at standard video resolution, approximately 2K×1K pixels, for example. Satellite image guided geo-localization techniques described herein typically can determine a three DoF pose for a vehicle 110 that is within one meter in x, y location and one degree of yaw orientation, which is more accurate than the 3+ meter location and 3+ degree orientation accuracy of an estimated three DoF pose 302. Satellite image guided geo-localization techniques determine a three DoF pose for a vehicle 110 by determining locations of fields of view 208, 210, 212, 214 with respect to a satellite image 200 by extracting 3D feature points from images and matching them to 3D feature points extracted from a satellite image 200.

Given a coarse location and orientation of a ground camera, the disclosed systems and methods refine this pose through ground-to-satellite image registration. In contrast to previous techniques that assume a large training dataset with highly accurate pose labels for ground images, the disclosed pose refinement techniques include self-supervised learning strategies that do not require such labels.

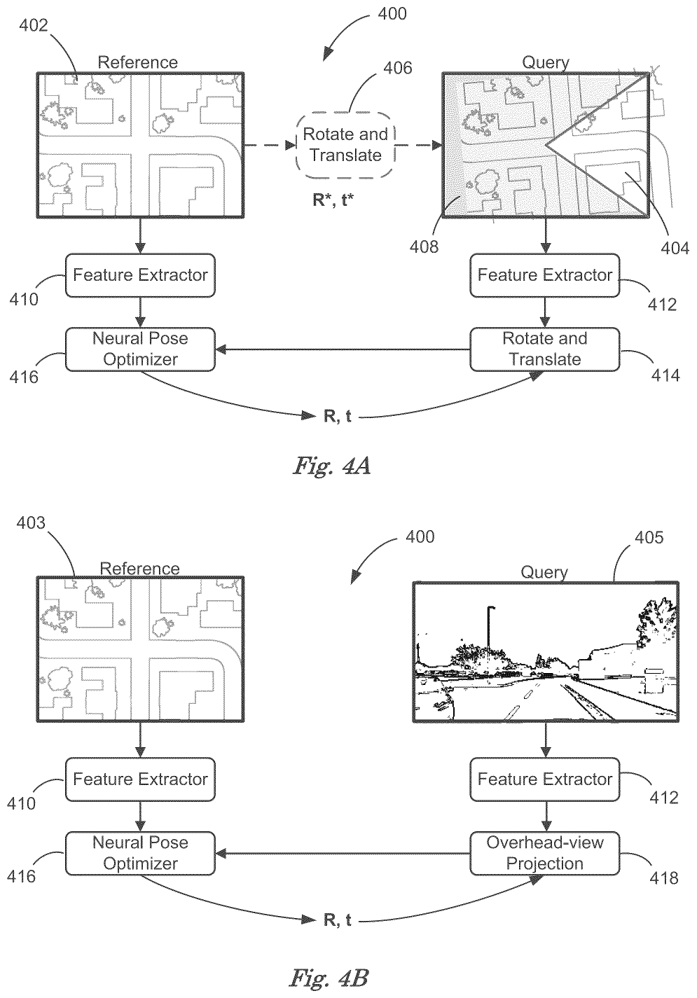

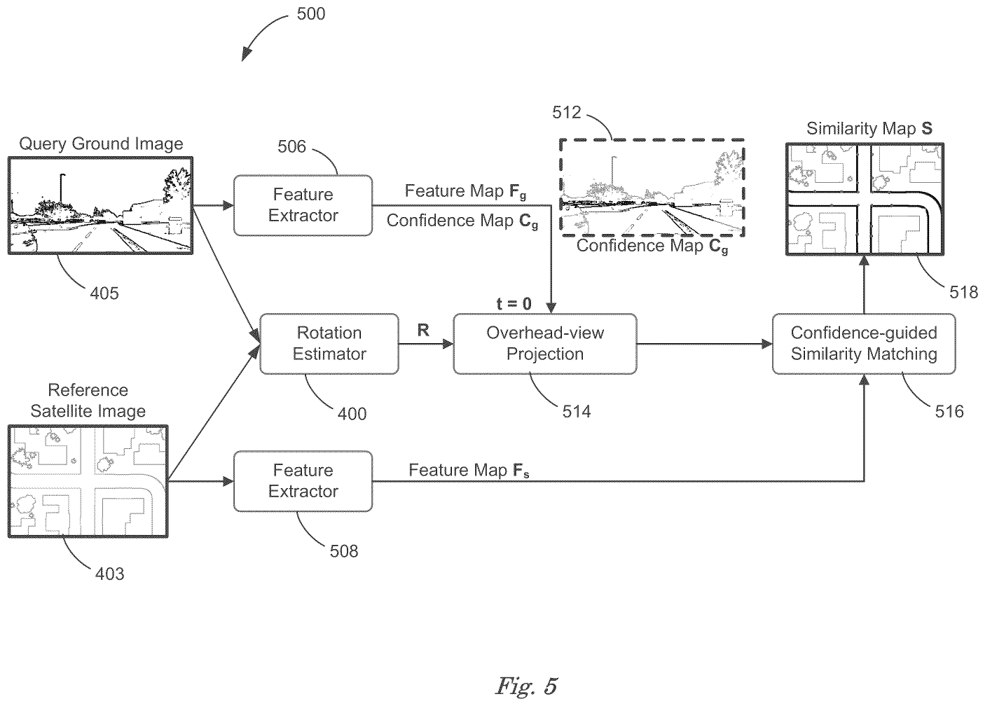

The disclosed systems and methods for camera pose refinement with ground-to-satellite image registration include two stages. The first stage uses a rotation estimator 400 (FIG. 4B) to predict the rotation alignment between a ground view image and an aerial view image (e.g., a satellite image). In the second stage, a translation estimator 500 (FIG. 5) estimates a translation between the ground view image and the aerial view image based on an estimated rotation from the rotation estimator 400. The rotation estimator 400 and the translation estimator 500 can be implemented with software instructions operating on a vehicle computer such as the computing device 115 included in the vehicle 110. The rotation estimator 400 and translation estimator 500 can be trained on the server computer 120 and downloaded or otherwise installed to the computing device 115 in the vehicle 110.

As shown in FIG. 4A, in order to train the rotation estimator 400, satellite image-based reference and query image pairs (402, 404) can be generated with accurate relative poses. This is accomplished by rotating and translating 406 a reference satellite image 402 using a randomly generated pose, R*, t*. A mask 408 can be applied to the transformed (i.e., rotated and translated) satellite image to extract a triangle region corresponding to a ground camera's FoV. This technique provides a synthesized ground-view image 404 derived from the reference satellite image 402. Thus, the relative pose between the reference satellite image 402 and the synthesized ground-view image 404 is known. For training the rotation estimator 400 the synthesized ground-view image 404 is used as the query image and the original satellite image 402 is used as the reference image.

A two-branch feature extractor is used to extract deep features from the reference and query images. A reference feature extractor 410 can determine a reference satellite feature map and a query feature extractor 412 can determine a query feature map. Based on an initialized pose (often the coarse pose to be refined), the query feature map is rotated and translated 414. The differences between the query feature map and the reference satellite image feature map are taken as the input of a neural pose optimizer 416, which outputs an updated relative pose (R, t) between the reference and query maps. The neural pose optimizer 416 is implemented from coarse-to-fine feature levels so as to provide global search as well as fine-tuning around local minima. The network can be supervised by:

$${ℒ}_{1} = {\sum }_{l} \vert {R}^{l} - {R}^{*} \vert + \vert {t}^{l} - {t}^{*} \vert , \qquad ( 1 )$$

where R^{l} and t^{l} denote the network prediction at feature level l, R* and t* indicates the corresponding ground truth, the 1-DoF inplane rotation R corresponds to the yaw angle of a ground camera, and the 2-DoF translation t corresponds to the ground camera's location along the latitude and longitude directions, and |⋅| denote the L₁ norm.

With reference to FIG. 4B, once the rotation estimator 400 has been trained, query ground images 405 can be input into the rotation estimator 400 during inference. The projection geometry of satellite images and ground images captured by a pin-hole camera is similar. They both map straight lines in the real world to straight lines in images. Thus, their feature extractor can be shared. In other words, the weights can be shared for the feature extractors 410 and 412. The rotate and translate block 414 from the training stage can be replaced with an overhead-view projection module 418 to handle the viewpoint differences between satellite 403 and ground views 405 during evaluation. The overhead-view projection module 418 exploits the ground plane homography to project ground-view observations to the overhead view, and it is learnable parameter-free. Output from the neural pose optimizer 416 is taken as the estimated relative pose between the ground view 405 and satellite images 403.

Neural network outputs can be sensitive to rotations of the input, meaning that even slight differences in rotation can be amplified in the network output. As a result, the pose optimizer 416, constructed using neural networks, shows good performance in rotation estimation. In contrast, the translation difference in the input signals may be absorbed by high-level deep features inside the neural optimizer 416 due to the aggregation layers, making it agnostic to the translation differences in input images. This can result in less than optimum translation estimation performance. However, the equivariance property of convolutional neural networks to translations means the relative translation between two input signals can be recovered by spatial correlation. Therefore, in the above mentioned second stage, the translation is estimated based on an estimated rotation from the rotation estimator 400 using spatial correlation. The translation estimate from the rotation estimator 400 is ignored in favor of the spatial correlation-based translation estimate.

FIG. 5 is a diagram of a satellite image guided pose refinement system 500 as described herein. The satellite image guided pose refinement system 500 can be executed on a computing device 115 included in a vehicle 110. The pose refinement system 500 can input images 405 from vehicle sensors and satellite images 403 from computing device 115 memory or downloaded from the Internet and outputs a high-definition estimated three DoF pose for a vehicle 110. The satellite image 403 can be selected based on the estimated three DoF pose 302 of the vehicle 110 and retrieved from memory or downloaded from a network 130, e.g., including via the Internet, to computing device 115.

As shown in FIG. 5, the pose refinement system 500 estimates the translation with a two-branch convolutional network that is applied to the satellite image 403 and the ground view image 405. The two branches 506, 508 can share weights when ground images are captured by a pin-hole camera. However, they do not share weights when ground images are panoramas. This is because the spherical projection of panoramas maps straight lines in the real world to curves in images. Thus, the learned feature patterns for satellite images and ground panoramas are not shareable. Each branch can be a U-Net architecture and extracts multi-level representations of the original images.

For the ground branch feature extractor 506, not only the feature representation F^{l}_{g}∈ [symbol] ^{Hg×Wg×C} but also a confidence map C^{l}_{g}∈ [symbol] ^{Hg×Wg×1} at the feature level l is extracted. The confidence map 512 indicates whether features at corresponding spatial pixel positions are trustworthy. For example, dynamic objects (e.g., cars) in the images may be detrimental to localization performance, while the road structures are the features of interest. The higher the confidence, the more reliable the corresponding features. It should be noted that no explicit supervision is applied to the confidence map 512. Instead, it is encoded in the cross-view similarity matching process and learned statistically from the similarity-matching training objective.

The satellite branch feature extractor 508 only extracts feature representations F^{l}ₛ∈ [symbol] ^{Hs×Ws×C} for the satellite branch at feature level l with no confidence map because the inventors empirically determined that learning confidence maps for satellite images impairs the performance. The reasons hypothesized are twofold: (1) dynamic objects are fewer on the satellite images, and they occupy a relatively smaller region on the satellite image compared to ground-view images; thus, they have a lower impact on localization performance; and (2) neither the camera poses, nor the confidence maps, have explicit supervision, thus learning a confidence map for satellite images increases the network training difficulty.

The feature extractors 410, 412, 506, 508 can be convolutional neural networks (CNN) that include convolutional layers followed by fully connected layers. Convolutional layers extract latent variables that indicate locations of feature points by convolving input images, such as images 405, with a series of convolution kernels. Latent variables are input to fully connected layers that determine feature points by combining the latent variables using linear and non-linear functions. Convolution kernels and the linear and non-linear functions are programmed using weights determined by training the feature extractors.

The trained rotation estimator 400 estimates the relative rotation between the ground view images 405 and satellite images 403. Then, the ground-view features and confidence maps are projected to the overhead view according to the estimated rotation R and zero translation t=0. Similar to that in FIG. 4B, the overhead-view projection 514 leverages the ground plane homography and is learnable parameter-free. F^{l}_{g} and C^{l}_{g} represent the projected ground features and confidence maps, respectively, at feature level l. A ground plane in this context is a plane that is coincident with roadways or other surfaces that support vehicles such as parking lots.

Confidence guided feature matching 516 can be used with spatial correlation to determine the translation. Given that the rotation of the projected overhead-view feature map 514 has been aligned with the observed satellite feature map Fₛ, the only remaining disparity between them is a translation difference. The translation difference is the distance and direction between the initial pose and the predicted pose, which can be expressed as x and y displacements from the initial pose measured in meters, for example. To compute this translation difference, spatial correlation is utilized. Specifically, the projected overhead-view feature map 514 is used as a sliding window, and its inner product with the reference satellite feature map Fₛ is computed when aligned at varying locations. This generates a similarity score S^{l}(u,v) between the two view features at the same level l when aligned at each location (u,v). These similarity scores can be presented in a similarity map 518. The mathematical representation of this spatial correlation process, taking into account ground-view confidence maps 512, is as follows:

$${S}^{l} ( u , v ) = ( {F}_{s}^{l} * \hat{{F}_{g}^{l}} ) ( u , v ) = \frac{{\sum }_{i} {\sum }_{j} {F}_{s}^{l} ( u + i , v + j ) \hat{{F}_{g}^{l}} ( i , j )}{\sqrt{{\sum }_{i} {\sum }_{j} {{F}_{s \vert}^{l}}^{2} ( u + i , v + j )} \sqrt{{\sum }_{i} {\sum }_{j} {\hat{{F}_{g}^{l}}}^{2} ( i , j )}} , \qquad ( 2 )$$

Where [symbol] =C^{l}_{g}F^{l}_{g} is to highlight important features while suppressing nonreliable features for localization. The pixel coordinate corresponding to the maximum similarity indicates the most likely ground camera's location (û,\hat{v})=arg max_{(u,v)} S^{max(l)} at the finest feature level. The difference between (û,\hat{v}) and the initial location estimate (e.g., estimated three DoF pose 302) is the translation. Using this translation and the rotation estimate the initial location 302 can be refined (e.g., translated and rotated) to a high-definition pose.

The network can be trained using a combination of self-supervised learning and weak supervision depending on the relative accuracy of the available training data. In “self-supervised learning” described herein the pose error of ground images in the training data is the same as the pose error of ground images that are to be enhanced during deployment. For example, the coarse pose estimation of training and testing sets are from the same noisy GPS and compass sensors.

Deep metric learning can be used for network self-supervision. For a query ground view image, a similarity map is determined based on the possible locations between it and its matching and non-matching satellite images, denoted as S^{l}ₚₒₛ and S^{l}_{neg}, respectively. The maximum similarity in S^{l}ₚₒₛ is maximized while minimizing the maximum similarity in S^{l}_{neg}:

$${ℒ}_{2} = {\sum }_{l} log ( 1 + {e}^{α ( {maxS}_{neg}^{l} - {maxS}_{pos}^{l} )} ) , \qquad ( 3 )$$

where α controls the convergence speed and can be set to 10, for example.

Weak supervision can be used in examples where relatively more accurate location labels for ground view images are available in the training data when compared to the accuracy of the poses to be refined during employment. The statistical location error is denoted as d meters in the training data. An additional training objective can incorporate this signal as follows:

$${ℒ}_{3} = {\sum }_{l} \vert max ( {S}_{pos}^{l} ) - max ( {S}_{pos}^{l} [ {u}^{*} - \frac{d}{γ} : {u}^{*} + \frac{d}{γ} , {v}^{*} - \frac{d}{γ} : {v}^{*} + \frac{d}{γ} ] ) \vert , \qquad ( 4 )$$

where (u*,v*) indicates the location label provided by the training data and has an error of up to d meters, γ denotes the ground resolution of the similarity map in terms of meters per pixel. This training objective forces the global maximum in the similarity map to equal a local maximum, with the local region centered at the location label with a radius of d meters. The combined training objective for the weakly supervised version is L=L₂+L₃. The statistical location error d can be set to d=5 meters. The training objective can be the combined training loss for the translation estimation and is denoted as:

$$ℒ = {ℒ}_{2} + {λℒ}_{3} , \qquad ( 5 )$$

where λ=0 indicates the network is trained in a fully self-supervised manner.

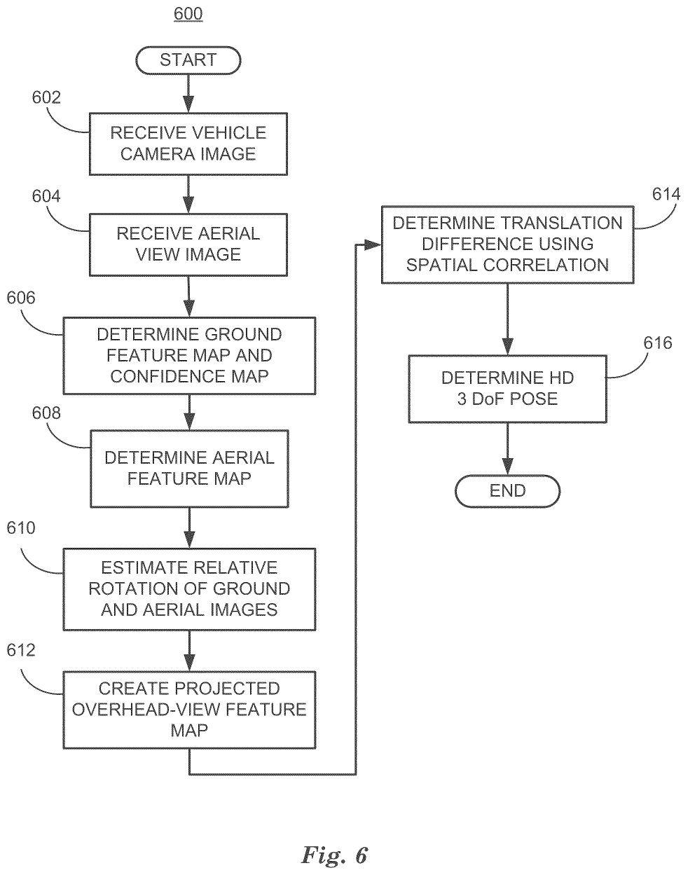

FIG. 6 is a flowchart, described in relation to FIGS. 1-5, of a process 600 for determining a high-definition estimated three DoF pose based on satellite image guided geo-localization. Process 600 can be implemented in the computing device 115 included in the vehicle 110. Process 600 includes multiple blocks that can be executed in the illustrated order. Process 600 could alternatively or additionally include fewer blocks or can include the blocks executed in different orders.

Process 600 begins at block 602 where the computing device 115 in the vehicle 110 receives images 405 from one or more video cameras included in the vehicle 110. The one or more images 405 include image data regarding an environment around the vehicle 110 and can include any portion of the environment around the vehicle including overlapping fields of view 208, 210, 212, 214 as long as the images 405 include data regarding a ground plane, where the ground plane is a plane coincident with a roadway or surface that supports the vehicle 110.

At block 604 computing device 115 receives an aerial view image (e.g., a satellite image 403). The satellite image 403 can be acquired by downloading the satellite image 403 from the Internet via network 130, for example. The satellite image 403 can also be retrieved from memory included in computing device 115. Satellite images 403 include location data in global coordinates that can be used to determine the location in global coordinates of any point in the satellite image 403. Satellite image 403 can be selected to include an estimated three DoF pose 302. The estimated three DoF pose 302 can be determined by acquiring data from vehicle sensors 116, for example GPS.

At block 606 computing device 115 inputs the received ground view images 405 to a trained first neural network, e.g., feature extractor 506. The first neural network can be trained on a server computer 120 and downloaded or otherwise installed to the computing device 115 in the vehicle 110. The first neural network determines ground feature maps F_{g} and ground confidence maps C_{g} corresponding to the acquired ground view images 405.

At block 608 computing device 115 also inputs the received aerial view image, e.g., satellite image 403, to a trained second neural network, e.g., feature extractor 508. The second neural network can be trained on the server computer 120 and downloaded or otherwise installed to the computing device 115 in the vehicle 110. The second neural network determines an aerial feature map Fₛ corresponding to the acquired aerial view image 403.

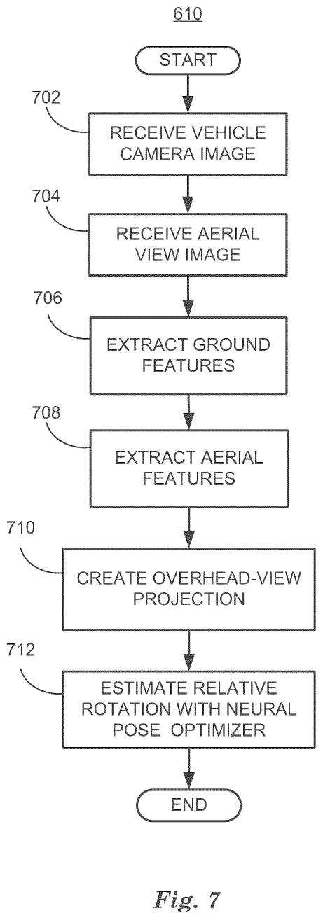

At block 610 computing device 115 estimates a relative rotation between the ground view image 405 and the aerial view image 403 with a rotation estimator 400. The rotation estimator process is described further below with respect to FIG. 7.

At block 612 computing device 115 creates a projected overhead-view feature map 514. Computing device 115 projects the ground feature map F_{g} and the confidence map C_{g} corresponding to the ground view image 405 to the aerial feature map Fₛ corresponding to the aerial view image 403 according to the relative rotation to create the projected overhead-view feature map 514.

At block 614 computing device 115 determines a translation difference between the projected overhead-view feature map 514 and the aerial feature map Fₛ using spatial correlation.

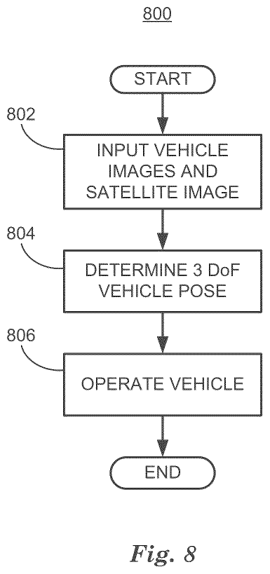

At block 616 computing device 115 determines a high-definition estimated three DoF pose of a ground view camera based on the relative rotation and the translation difference. The computing device 115 outputs the high-definition estimated three DoF estimated pose to be used to operate vehicle 110 as described in relation to FIG. 8, below. Following block 616 process 600 ends.

FIG. 7 is a flowchart, described in relation to FIGS. 1-6, of the process 610 for determining a rotation estimate, as introduced in FIG. 6. Process 610 can be implemented in the computing device 115 included in the vehicle 110. Process 610 includes multiple blocks that can be executed in the illustrated order. Process 610 could alternatively or additionally include fewer blocks or can include the blocks executed in different orders.

Process 610 begins at block 702 where the computing device 115 in the vehicle 110 receives the ground view images 405 from cameras included in the vehicle 110.

At block 704 the computing device 115 receives the aerial view image (e.g., the satellite image 403). The satellite image 403 can be acquired by downloading the satellite image 403 from the Internet via network 130, for example. The satellite image 403 can also be retrieved from memory included in computing device 115.

At block 706 computing device 115 inputs the received ground view images 405 to a trained third neural network, e.g., feature extractor 412, to extract ground features from the ground view image 405. The third neural network can be trained on the server computer 120 and downloaded or otherwise installed to the computing device 115 in the vehicle 110.

At block 708 computing device 115 also inputs the received aerial view image, e.g., satellite image 403, to a trained fourth neural network, e.g., feature extractor 410, to extract aerial features from the aerial view image 403. The fourth neural network can be trained on the server computer 120 and downloaded or otherwise installed to the computing device 115 in the vehicle 110. In an example, the third and fourth neural networks can be the same. In other words, the weights can be shared for the third and fourth neural networks.

At block 710 computing device 115 projects the ground features to the aerial features to create an overhead view projection 418.

At block 712 computing device 115 estimates the relative rotation between the ground features and the overhead view projection 418 with a neural pose optimizer 416. The neural pose optimizer 416 can be trained on the server computer 120 and downloaded or otherwise installed to the computing device 115 in the vehicle 110.

The rotation estimator 400, e.g., feature extractors 410, 412 and neural pose optimizer 416, can be trained by randomly rotating and translating aerial training images 402 and extracting a triangle region of the randomly rotated and translated aerial training images to derive a synthesized ground-view image 404. The rotation estimator can be trained based on the aerial training images 402 and the randomly rotated and translated aerial training images i.e., synthesized ground-view image 404.

FIG. 8 is a flowchart, described in relation to FIGS. 1-7 of a process 800 for operating a vehicle 110 based on a high-definition estimated three DoF pose determined based on the satellite image guided pose refinement system 500. Process 800 can be implemented by computing device 115 included in the vehicle 110. Process 800 includes multiple blocks that can be executed in the illustrated order. Process 800 could alternatively or additionally include fewer blocks or can include the blocks executed in different orders.

Process 800 begins at block 802, where the computing device 115 in the vehicle 110 acquires one or more ground view images 405 from one or more video cameras included in the vehicle 110 and acquires the satellite image 403 by downloading via a network 130 or retrieving from memory included in computing device 115. An estimated three DoF pose 302 for vehicle 110 is determined based on data acquired by vehicle sensors 116.

At block 804 computing device 115 enhances the estimated three DoF pose 302 to a high-definition estimated three DoF pose by processing the one or more ground view images 405 and the satellite image 403 with a satellite image guided pose refinement system 500 as described in relation to FIGS. 4A-6.

At block 806 computing device 115 uses the high-definition estimated three DoF pose to determine a vehicle path for the vehicle 110. The vehicle can operate on a roadway based on a vehicle path by determining commands to direct the vehicle's propulsion (e.g., powertrain), braking, and steering subsystems to operate the vehicle so as to travel along the path. A vehicle path is typically a polynomial function upon which a vehicle 110 can be operated. Sometimes referred to as a path polynomial, the polynomial function can specify a vehicle location (e.g., according to x, y, and z coordinates) and/or pose (e.g., roll, pitch, and yaw), over time. That is, the path polynomial can be a polynomial function of degree three or less that describes the motion of a vehicle on a ground surface. Motion of a vehicle on a roadway is described by a multi-dimensional state vector that includes vehicle location, orientation, speed, and acceleration. Specifically, the vehicle motion vector can include positions in x, y, z, yaw, pitch, roll, yaw rate, pitch rate, roll rate, heading velocity and heading acceleration that can be determined by fitting a polynomial function to successive 2D locations included in the vehicle motion vector with respect to the ground surface, for example. Further for example, the path polynomial p(x) is a model that predicts the path as a line traced by a polynomial equation. The path polynomial p(x) predicts the path for a predetermined upcoming distance x, by determining a lateral coordinate p, e.g., measured in meters:

$$p ( x ) = {a}_{0} + {a}_{1} x + {a}_{2} {x}^{2} + {a}_{3} {x}^{3} \qquad ( 6 )$$

where a₀ an offset, e.g., a lateral distance between the path and a center line of the vehicle 110 at the upcoming distance x, a₁ is a heading angle of the path, a₂ is the curvature of the path, and a₃ is the curvature rate of the path.

The polynomial function can be used to direct the vehicle 110 from a current location indicated by the high-definition estimated three DoF pose to another location in an environment around the vehicle while maintaining minimum and maximum limits on lateral and longitudinal accelerations. The vehicle 110 can be operated along a vehicle path by transmitting commands to subsystems 112, 113, 114 to control vehicle propulsion, steering and brakes. Following block 806 process 800 ends.

Computing devices such as those described herein generally each includes commands executable by one or more computing devices such as those identified above, and for carrying out blocks or steps of processes described above. For example, process blocks described above may be embodied as computer-executable commands.

Computer-executable commands may be compiled or interpreted from computer programs created using a variety of programming languages and/or technologies, including, without limitation, and either alone or in combination, Java™, C, C++, Python, Julia, SCALA, Visual Basic, Java Script, Perl, HTML, etc. In general, a processor (e.g., a microprocessor) receives commands, e.g., from a memory, a computer-readable medium, etc., and executes these commands, thereby performing one or more processes, including one or more of the processes described herein. Such commands and other data may be stored in files and transmitted using a variety of computer-readable media. A file in a computing device is generally a collection of data stored on a computer readable medium, such as a storage medium, a random-access memory, etc.

A computer-readable medium (also referred to as a processor-readable medium) includes any non-transitory (i.e., tangible) medium that participates in providing data (i.e., instructions) that may be read by a computer (e.g., by a processor of a computer). Such a medium may take many forms, including, but not limited to, non-volatile media and volatile media. Instructions may be transmitted by one or more transmission media, including fiber optics, wires, wireless communication, including the internals that comprise a system bus coupled to a processor of a computer. Common forms of computer-readable media include, for example, RAM, a PROM, an EPROM, a FLASH-EEPROM, any other memory chip or cartridge, or any other medium from which a computer can read.

All terms used in the claims are intended to be given their plain and ordinary meanings as understood by those skilled in the art unless an explicit indication to the contrary is made herein. In particular, use of the singular articles such as “a,” “the,” “said,” etc. should be read to recite one or more of the indicated elements unless a claim recites an explicit limitation to the contrary.

The term “exemplary” is used herein in the sense of signifying an example, e.g., a candidate to an “exemplary widget” should be read as simply referring to an example of a widget.

The adverb “approximately” modifying a value or result means that a shape, structure, measurement, value, determination, calculation, etc. may deviate from an exactly described geometry, distance, measurement, value, determination, calculation, etc., because of imperfections in materials, machining, manufacturing, sensor measurements, computations, processing time, communications time, etc.

In the drawings, the same candidate numbers indicate the same elements. Further, some or all of these elements could be changed. With regard to the media, processes, systems, methods, etc. described herein, it should be understood that, although the steps or blocks of such processes, etc. have been described as occurring according to a certain ordered sequence, such processes could be practiced with the described steps performed in an order other than the order described herein. It should be understood that certain steps could be performed simultaneously, that other steps could be added, or that certain steps described herein could be omitted. In other words, the descriptions of processes herein are provided for the purpose of illustrating certain embodiments and should in no way be construed so as to limit the claimed invention. Any use of “based on” and “in response to” herein, including with reference to media, processes, systems, methods, etc. described herein, indicates a causal relationship, not merely a temporal relationship.

1. A system, comprising:
a computer that includes a processor and a memory, the memory including instructions executable by the processor to:
estimate a relative rotation between a ground view image and an aerial view image with a rotation estimator;
project a ground feature map and a confidence map corresponding to the ground view image to an aerial feature map corresponding to the aerial view image according to the relative rotation to create a projected overhead-view feature map;
determine a translation difference between the projected overhead-view feature map and the aerial feature map using spatial correlation; and
determine a high-definition estimated three degree-of-freedom pose of a ground view camera based on the relative rotation and the translation difference.

2. The system of claim 1, wherein the instructions further comprise instructions to determine the ground feature map and the confidence map from the ground view image with a first neural network and instructions to determine the aerial feature map from the aerial view image with a second neural network.

3. The system of claim 1, wherein the instructions further comprise instructions to supervise the system using a combination of self-supervised learning and weak supervision.

4. The system of claim 1, wherein the rotation estimator includes instructions to extract ground features from the ground view image with a third neural network and extract aerial features from the aerial view image with a fourth neural network.

5. The system of claim 4, wherein the rotation estimator instructions further comprise instructions to project the ground features to the aerial features to create an overhead view projection.

6. The system of claim 5, wherein the rotation estimator instructions further comprise instructions to estimate the relative rotation between the ground features and the overhead view projection with a neural pose optimizer.

7. The system of claim 1, wherein the instructions to estimate the three degree-of-freedom pose of the ground view camera comprise instructions to estimate the three degree-of-freedom pose based on an initial estimate of the three degree-of-freedom pose of the ground view camera.

8. The system of claim 2, wherein the first and second neural networks have a U-net architecture.

9. The system of claim 1, wherein the instructions further comprise instructions to output the high-definition estimated three degree-of-freedom pose of the ground view camera to operate a vehicle.

10. The system of claim 9, further comprising a vehicle computer configured to determine a vehicle path upon which to operate the vehicle based on the high-definition estimated three degree-of-freedom pose of the ground view camera and the aerial view image.

11. A method, comprising:
estimating a relative rotation between a ground view image and an aerial view image with a rotation estimator;
projecting a ground feature map and a confidence map corresponding to the ground view image to an aerial feature map corresponding to the aerial view image according to the relative rotation to create a projected overhead-view feature map;
determining a translation difference between the projected overhead-view feature map and the aerial feature map using spatial correlation; and
determining a high-definition estimated three degree-of-freedom pose of a ground view camera based on the relative rotation and the translation difference.

12. The method of claim 11, further comprising determining the ground feature map and the confidence map from the ground view image with a first neural network and determining the aerial feature map from the aerial view image with a second neural network.

13. The method of claim 12, further comprising supervising the first and second neural networks using a combination of self-supervised learning and weak supervision.

14. The method of claim 11, further comprising randomly rotating and translating aerial training images and training the rotation estimator based on the aerial training images and the randomly rotated and translated aerial training images.

15. The method of claim 14, further comprising extracting a triangle region of the randomly rotated and translated aerial training images.

16. The method of claim 11, wherein estimating the relative rotation includes extracting ground features from the ground view image with a third neural network and extracting aerial features from the aerial view image with a fourth neural network.

17. The method of claim 16, wherein estimating the relative rotation includes projecting the ground features to the aerial features to create an overhead view projection.

18. The method of claim 17, wherein estimating the relative rotation includes estimating the relative rotation between the ground features and the overhead view projection with a neural pose optimizer.

19. The method of claim 11, wherein the estimated three degree-of-freedom pose of the ground view camera is determined based on an initial estimate of the three degree-of-freedom pose of the ground view camera.

20. The method of claim 11, further comprising outputting the high-definition estimated three degree-of-freedom pose of the ground view camera to operate a vehicle.
